(19) United States
(12) Patent Application Publication
(10) Pub. No.: US 2012/0298876 A1
(43) Pub. Date: Nov. 29, 2012

(54) RADIATION DETECTOR, SCINTILLATOR, AND METHOD FOR MANUFACTURING SCINTILLATOR

(75) Inventors: Yasuhisa KANEKO, Kanagawa (JP); Haruyasu NAKATSUGAWA, Kanagawa (JP)

(73) Assignee: FUJIFILM CORPORATION, Tokyo (JP)

(21) Appl. No.: 13/475,470

(22) Filed: May 18, 2012

(30) Foreign Application Priority Data
May 27, 2011 (JP) 2011-118677

(51) Int. Cl. G01T 1/20; B05D 5/06

(52) U.S. Cl. 250/366; 250/487.1; 427/157

(57) ABSTRACT

A scintillator for converting radiation into light includes a first conversion layer being a planar phosphor and a second conversion layer having columnar phosphors. To form the columnar phosphors of the second conversion layer, optical fibers of a fiber optic plate are filled with a phosphor paste. The columnar phosphors produce a light guide effect. The phosphors of both the first and second conversion layers contain GOS particles dispersed in a resin binder.

### BACKGROUND OF THE INVENTION

1. Field of the Invention

The present invention relates to an indirect conversion type radiation detector for electrically detecting a radiographic image, a scintillator used in the detector, and a manufacturing method of the scintillator.

2. Description Related to the Prior Art

A radiation imaging device that has a scintillator and an indirect conversion type radiation detector is in practical use. The scintillator converts radiation, for example, X-rays into light. The indirect conversion type radiation detector has a sensor panel composed of a two-dimensional array of pixels each for converting the light into an electric signal. The radiation imaging device takes a radiograph using the radiation that has been passed through an object.

The indirect conversion type radiation detector adopts either a penetration side sampling (PSS) method or an irradiation side sampling (ISS) method. In the PSS method, the scintillator and the sensor panel are disposed in this order from a radiation irradiation side. The scintillator converts the radiation into light, and the sensor panel detects the light. In the ISS method, on the other hand, the sensor panel and the scintillator are disposed in this order from the radiation irradiation side. The radiation passed through the sensor panel is converted into the light in the scintillator, and the sensor panel detects the light. The scintillator emits the light more strongly at its radiation incident side. Thus, the ISS method, having the sensor panel on the radiation incident side of the scintillator, can provide higher sensitivity and higher resolution of the radiograph, as compared with the PSS method.

Japanese Patent Laid-Open Publication No. 2002-181941, for example, discloses an example of the radiation detector of the PSS method. This radiation detector uses a two-layer scintillator that is composed of a columnar phosphor layer made of GOS (Gd₂O₂S:Tb) and a planar phosphor layer laminated in this order from the radiation irradiation side. The sensor panel detects the light from the planar phosphor layer. In this scintillator, the light produced by entrance of the radiation propagates through the columnar phosphor layer with total reflection to the sensor panel. This is a so-called light guide effect, and allows prevention of dispersion of the light and improvement in image sharpness. The columnar phosphor layer on the radiation irradiation side has particles of a large diameter, to increase the sensitivity of the scintillator. The planar phosphor layer has particles of a small diameter, and a binder has a large refractive index. Thus, the light can enter an appropriate pixel with prevention of divergence, and this allows increase in the image sharpness.

Japanese Patent Laid-Open Publication No. 2010-121997, for example, discloses an example of the radiation detector of the ISS method. This radiation detector uses a two-layer scintillator having first and second phosphor layers. A detector (sensor panel) is disposed on the radiation irradiation side, and the scintillator is laid out such that the second phosphor layer is opposed to the detector. In this scintillator, making the thick scintillator having the two phosphor layers increases photoelectric conversion efficiency of the radiation. Also, a light absorbing material is added to the first phosphor layer laid out on a far side from the detector. The light absorbing material absorbs side-scattered light of the light converted in the first phosphor layer, and facilitates improvement in the image sharpness.

The Japanese Patent Laid-Open Publication No. 2010-121997 also describes a two-layer scintillator that has a first phosphor layer made of columnar crystals of cesium iodide (CsI) and a second phosphor layer made of GOS. To produce this scintillator, the CsI is evaporated onto an aluminum substrate, and is impregnated with a solution containing the light absorbing material. Then, the CsI is dried into the first phosphor layer. After that, a solution containing the GOS is applied to the CsI and dried into the second phosphor layer.

In the scintillator of the Japanese Patent Laid-Open Publication No. 2002-181941, the GOS processed into the form of columns is used as the columnar phosphor layer, to improve the sensitivity, resolution, and sharpness. This scintillator, however, is used in the PSS method not in the ISS method, and there is no description about application to the ISS method. If this scintillator is applied to the ISS method as-is, the sensor panel is laid out on the radiation incident side of the scintillator. In this case, the planar phosphor layer is positioned away from the sensor panel, so the structure of the scintillator becomes complicated and results in cost increase. Furthermore, no effect of the use of the columnar phosphor layer can be obtained.

Moreover, screen printing and sandblasting are used to process the GOS into the columnar form. These processing methods, however, cannot form columns having a diameter of a pixel size or less of the sensor panel. This causes deterioration of the image sharpness.

The scintillator of the Japanese Patent Laid-Open Publication No. 2010-121997 uses the columnar crystals of the CsI. Thus, the scintillator can obtain the light guide effect due to the use of the columnar crystals, without application of any process to form columns. However, the CsI is expensive. Furthermore, since the CsI is brittle, an anti-breakage protection structure is required. The scintillator is contained in a housing together with the sensor panel, for use as a part of an electronic cassette, for example. At this time, this electronic cassette is sometimes put under a patient lying down on a bed. Thus, high rigidity is required of the electronic cassette, such that the body weight of the patient does not cause breakage of the CsI. This causes increase in the weight of the electronic cassette, and impairs practicality.

The CsI is evaporated onto the substrate and forms the columnar crystals. The columnar crystals of the CsI is made into the first phosphor layer, and the second phosphor layer is formed on the first phosphor layer by application of the GOS. The GOS gets into gaps between the columnar crystals of the CsI, and hence reduces the light guide effect of the columnar crystals of the CsI.

### SUMMARY OF THE INVENTION

A main object of the present invention is to provide a scintillator having an inexpensive and tough columnar phosphor layer, a manufacturing method of the scintillator, and a radiation detector having the scintillator.

Another object of the present invention is to provide the scintillator that has a fine light guide effect and the columnar phosphor layer with a small column diameter corresponding to a pixel size, the manufacturing method of the scintillator, and the radiation detector.

To achieve the above and other objects, a radiation detector according to the present invention includes a first conversion layer for converting radiation into light, a second conversion layer for converting the radiation into the light, and a sensor panel. The first conversion layer is formed of a planar phosphor. The second conversion layer is formed of a columnar phosphor. The second conversion layer is integrated with the first conversion layer to form a scintillator. The sensor panel is overlaid on the scintillator. The sensor panel has a detection surface having a two-dimensional array of pixels each for converting the light produced by the scintillator into an electric signal. The scintillator is disposed in a position such that the first conversion layer faces to a radiation irradiation side. The sensor panel is disposed in a position such that the detection surface faces to an outer surface of the first conversion layer.

The second conversion layer preferably includes a fiber optic plate made of a bundle of hollow optical fibers and a phosphor filling each of the optical fibers.

The radiation detector may further include a reflective layer for reflecting the light converted by the scintillator to the sensor panel. The reflective layer is formed on an outer surface of the second conversion layer. The reflective layer may be a mirror-finished metal plate.

A reflective film may be formed in an interior surface of each of the optical fibers. The reflective film may be an aluminum film.

The phosphor used in the first and second conversion layers is preferably a plastic scintillator. The plastic scintillator preferably contains GOS particles dispersed in a resin binder.

The first conversion layer is preferably thicker than the second conversion layer. The scintillator may be covered with a moisture-proof protective film.

A scintillator according to the present invention includes first and second conversion layers for converting radiation into light. The first conversion layer is formed of a planar phosphor. The second conversion layer has a fiber optic plate made of a bundle of hollow optical fibers and a phosphor filling each optical fiber.

A manufacturing method of the scintillator includes the steps of filling each of a plurality of optical fibers of a fiber optic plate with a phosphor paste to form a second conversion layer having a plurality of columnar phosphors; and applying the phosphor paste to one surface of the fiber optic plate to form a first conversion layer integrally with the columnar phosphors.

The filling step uses a capillary phenomenon by immersion of the optical fibers in the phosphor paste.

According to the present invention, the scintillator includes the columnar phosphors that are made of the hollow optical fibers filled with the phosphor. Thus, the scintillator is made inexpensive and tough, as compared with the columnar crystals of CsI. Also, use of the optical fibers produces a good light guide effect, and use of the optical fibers with a small diameter allows detection of a sharp radiographic image.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a partially broken perspective view of a radiation imaging device;

FIG. 2 is a schematic sectional view of the radiation imaging device;

FIG. 3 is a sectional view of a side end portion of a radiation detector;

FIG. 4 is a perspective view showing an appearance of a scintillator;

FIGS. 5A and 5B are explanatory views of a manufacturing procedure of the scintillator;

FIG. 6 is a schematic sectional view showing the structure of a photosensor;

FIG. 7 is a block diagram showing the electrical structure of the radiation imaging device;

FIG. 8 is a block diagram of a console and a radiation generating device;

FIG. 9 is an explanatory view that schematically shows a transmission state of light produced by the scintillator;

FIG. 10 is a sectional view of a side end portion of a radiation detector that has a reflective film in each optical fiber;

FIG. 11 is an explanatory view of the function of a scintillator in a radiation detector of an ISS method; and

FIG. 12 is an explanatory view of the function of a scintillator in a radiation detector of a PSS method.

### DESCRIPTION OF THE PREFERRED EMBODIMENTS

### First Embodiment

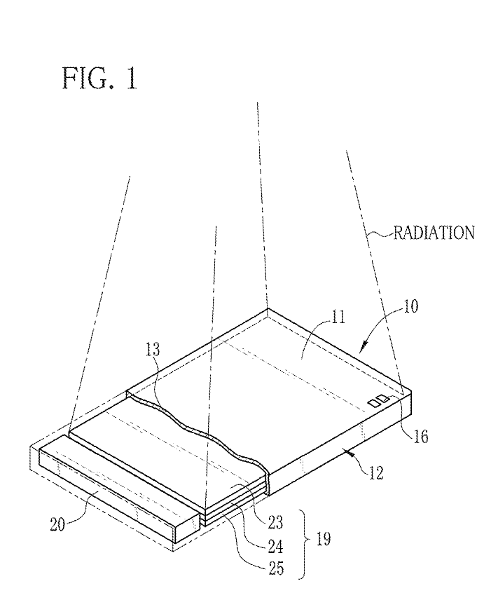

As shown in FIG. 1, a radiation imaging device 10 has a box-shaped housing 12. The housing 12 is provided with a top plate 13 at its top surface, which functions as a radiation receiving surface 11. The top plate 13 is made of carbon or the like, which allows radiation to transmit therethrough and ensures sufficient strength. The housing 12, excepting the top plate 13, is made of a radiation transparent material, for example, ABS resin or the like. The size of the housing 12 is the same size as that of a conventional cassette, which records an image on a photosensitive material by the radiation. Thus, the radiation imaging device 10 is usable in a conventional radiation imaging system instead of the conventional cassette.

The radiation receiving surface 11 of the radiation imaging device 10 is provided with an indicator 16 having plural LEDs. The indicator 16 indicates an operation state of the radiation imaging device 10, such as an operation mode (for example, on standby, on data transmission, and the like) and remaining battery charge. Note that, the indicator 16 may be composed of another type of light emitting elements other than the LEDs, or a display such as a liquid crystal display or an organic EL display. The indicator 16 may be provided in another location other than the radiation receiving surface 11.

The housing 12 of the radiation imaging device 10 contains a panel-shaped radiation detector 19 that detects the radiation transmitted through a body part of the patient H. The radiation detector 19 is opposed to the radiation receiving surface 11 in the housing 12. The housing 12 also contains a case 20 along its short side on one end of the radiation receiving surface 11. The case 20 encloses various electric circuits including a microcomputer and a detachable battery (secondary battery). The battery contained in the case 20 supplies electric power to various electric circuits of the radiation imaging device 10 including the radiation detector 19. A radiation shielding member (not shown) made of lead or the like is provided under the top plate 13 and above the case 20, for the purpose of preventing damage to the electric circuits contained in the case 20 by radiation irradiation.

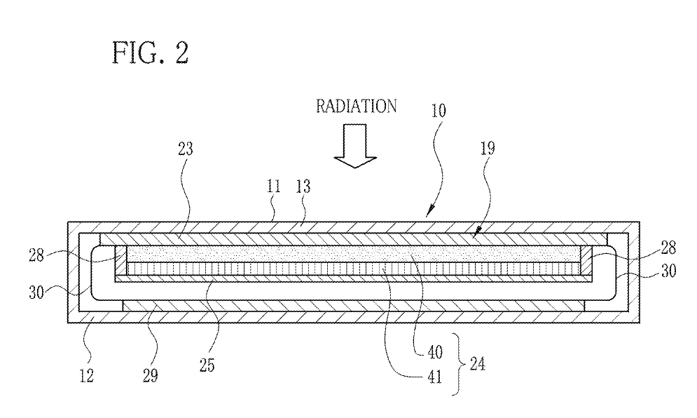

The radiation detector 19 is constituted of a sensor panel 23, a scintillator 24, and a reflective layer 25 laminated in this order in a radiation irradiation direction. As shown in FIG. 2, the sensor panel 23 is glued on an entire interior surface of the top plate 13 with an adhesive. The scintillator 24 is enclosed with a sealant 28 to protect the scintillator 24 from moisture and the like. A control board 29 is disposed on the bottom of the housing 12. The control board 29 is electrically connected to the sensor panel 23 through flexible cables 30.

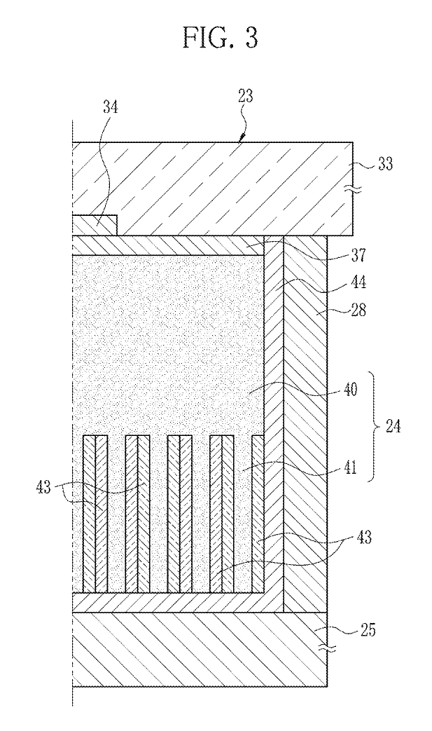

FIG. 3 shows a cross section of the radiation detector 19 on its end portion. The sensor panel 23, which detects light radiating from the scintillator 24, includes a rectangular flat sensor substrate 33 and a photosensor 34 provided in a bottom surface of the sensor substrate 33. As the sensor substrate 33, a heat-resistant glass substrate is used, such that photodiodes (PD) of the photosensor 34 can be formed by evaporation of amorphous silicon, for example. The thickness of the sensor substrate 33 is of the order of 700 μm, for example.

The scintillator 24 is glued onto the sensor panel 23 with an adhesive 37. The radiation passed through the patient's body part is applied to the housing 12, and enters the scintillator 24 through the top plate 13 and the sensor panel 23. The scintillator 24 absorbs the radiation, and emits the light. The scintillator is made of, for example, CsI:Tl (cesium iodide doped with thallium), CsI:Na (cesium iodide activated with sodium), GOS (Gd₂O₂S:Tb), or the like in general. In this embodiment, a plastic scintillator, which is made of phosphor particles e.g. GOS particles dispersed in a resin binder, is used as the scintillator 24, because the plastic scintillator is more inexpensive and harder to break than a scintillator of CsI.

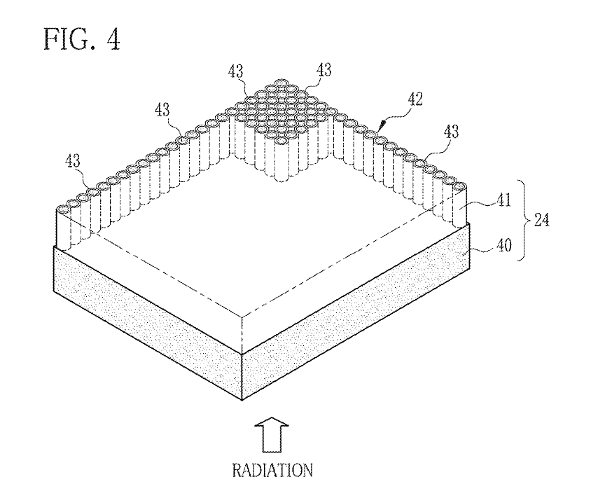

The scintillator 24 includes a planar first conversion layer 40 disposed on a radiation irradiation side so as to be opposed to the sensor panel 23, and a columnar second conversion layer 41 integrated with the first conversion layer 40. As shown in FIG. 4, the second conversion layer 41 includes a fiber optic plate (FOP) 42, being a bundle of hollow optical fibers 43, and each optical fiber 43 is filled with the GOS. The diameter of each optical fiber 43 is smaller than a pixel. This structure allows detection of a sharp radiographic image. The optical fiber 43 is made of glass or plastic.

In the scintillator 24, the first conversion layer 40 has a thickness of 300 μm, and the second conversion layer 41 has a thickness of 250 μm, for example. Thus, the total thickness of the scintillator 24 is 550 μm. This scintillator 24 obtains approximately the same emission amount as that of a conventional planar scintillator of GOS having a thickness of 500 μm. The total thickness of the scintillator 24 is made larger than that of the conventional planar scintillator, in order to compensate for reduction in the amount of the GOS used in the second conversion layer 41 relative to the amount of the GOS used in the conventional planar scintillator. Note that, the total thickness of the scintillator 24 and the thickness of each layer 41, 42 are described above as just examples, and not limited to above values.

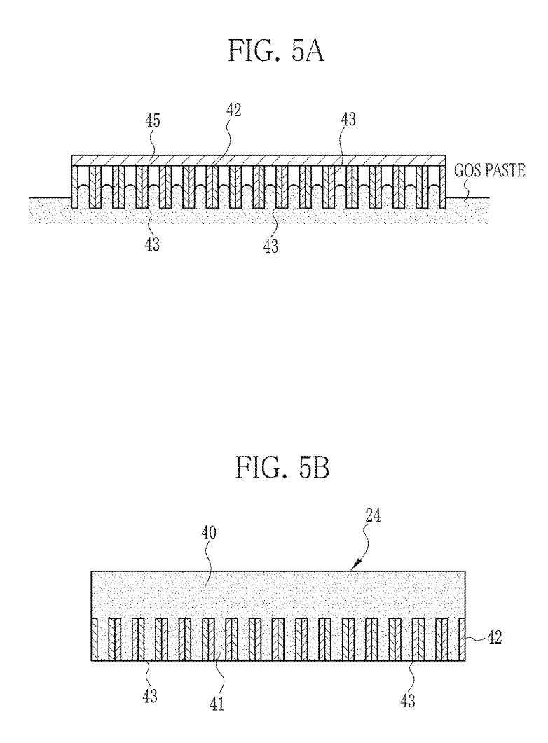

The scintillator 24 is manufactured as follows, by way of example. As shown in FIG. 5A, in a first step, one surface of the FOP 42, being a bundle of hollow optical fibers 43, is immersed in a GOS paste. In the GOS paste, the GOS particles are dispersed in the binder. Thus, each optical fiber 43 is filled with the GOS paste by a capillary phenomenon, so the second conversion layer 41 is formed. At this step, the other surface of the FOP 42 is preferably sealed with a tight sealing plate 45 such that the filling GOS paste does not flow out. Note that, the type of the binder used in the GOS paste, the viscosity of the GOS paste, and the like are appropriately changeable in accordance with the internal diameter of the optical fibers 43.

In the next step, as shown in FIG. 5B, another GOS paste is applied to the one surfaces of the FOP 42 to form the planar first conversion layer 40. Note that, the GOS paste used in the formation of the first conversion layer 40 has higher viscosity than the GOS paste used in the formation of the second conversion layer 41, to prevent the GOS paste from flowing down after the application. After that, the GOS pastes composing the first and second conversion layers 40 and 41 are dried and cured, so the scintillator 42, which integrally has the first and second conversion layers 40 and 41, is completed.

As described above, in the scintillator 24, the second conversion layer 41 having structure similar to that of the columnar crystals of CsI is formed out of the GOS. This contributes cost reduction, and prevents breakage of the scintillator 24 without provision of a reinforcing structure. Since the first and second conversion layers 40 and 41 are integrally formed, an air layer, which brings out undesired light reflection, does not occur between the first and second conversion layers 40 and 41, in contrast to a case where separately formed first and second conversion layers are glued into one unit. In the gluing case, glued portions deteriorate with time, but such deterioration does not occur in the scintillator 24.

The scintillator 24 is covered with a moisture-proof protective film 44 (see FIG. 3) in a state of being glued onto the sensor panel 23. As the protective film 44, an organic film manufactured by vapor phase polymerization such as a thermal CVD method or a plasma CVD method is used. The usable organic film includes a vapor-phase polymerized film formed of polyparaxylylene resin by the thermal CVD method, a plasma polymerized film formed of fluorine-containing composite unsaturated hydrocarbon monomer, and a plasma polymerized film formed of unsaturated hydrocarbon monomer. Alternatively, a lamination of the organic film and an inorganic film is usable. The inorganic film is preferably made of silicon nitride (SiNx), silicon oxide (SiOx), silicon oxynitride (SiOxNy), Al₂O₃, or the like.

The reflective layer 25 is made of a metal plate that has a mirror-finished surface at one surface opposed to the scintillator 24, for example. The reflective layer 25 reflects the light, which is converted from the radiation by the scintillator 24, to the sensor panel 23, in order to increase the amount of detection light and improve the sensitivity of the radiation detector 19. The reflective layer 25 is tightly joined to the scintillator 24 with the use of adhesion of the protective film 44, after the scintillator 24 is glued onto the sensor panel 23 and the protective film 44 covers the scintillator 24. In another case, the reflective layer 25 may be glued onto the scintillator 24 with a light-transparent adhesive.

In this embodiment, the sensor panel 23 is laid out on a radiation incident side of the scintillator 24, and such layout is called “irradiation side sampling (ISS) method”. The scintillator emits the light more strongly at its radiation incident side. The photosensor is disposed closer to the radiation incident side of the scintillator in the ISS method than in a penetration side sampling (PSS) method, in which the photosensor is laid out on a side opposite to the radiation incident side of the scintillator. Thus, the ISS method brings about increase of the resolution of the radiographic image. Also, the amount of light received by the photosensor is increased, so the sensitivity of the radiation imaging device is improved. In the case of the PSS method, the scintillator 24 is turned upside down such that the second conversion layer 41 comes to be the radiation incident side, and the sensor panel 23 is disposed so as to be opposed to the first conversion layer 40 of the scintillator 24.

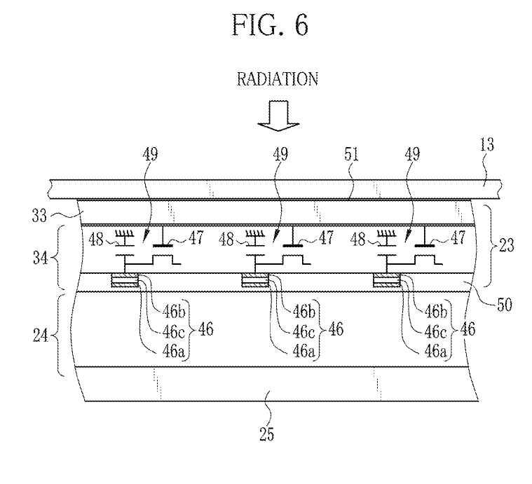

Next, the photosensor 34 of the sensor panel 23 will be described. As shown in FIG. 6, the photosensor 34 includes plural pixel units 49 formed into a matrix on the sensor substrate 33. Each pixel unit 49 is constituted of a photoelectric converter (pixel) 46 formed of the photodiode (PD) and the like, a thin film transistor (TFT) 47, and a capacitor 48. A flattening layer 50 is formed on a surface of the sensor panel 23 on a side opposite to the radiation irradiation direction. As described above, the sensor panel 23 is glued on the interior surface of the top plate 13 with an adhesive layer 51.

The photoelectric converter 46 is constituted of a lower electrode 46a, an upper electrode 46b, and a photoelectric conversion layer 46c sandwiched between the lower and upper electrodes 46a and 46b. The photoelectric conversion layer 46c absorbs the light radiating from the scintillator 24, and produces electric charge by an amount corresponding to the amount of the absorbed light. The lower electrode 46a is preferably made of a conductive material that is transparent to at least the wavelength of the light radiating from the scintillator 24. This is because the light from the scintillator 24 needs to be incident upon the photoelectric conversion layer 46c. More specifically, the lower electrode 46a is preferably made of transparent conducting oxide (TCO) that has high transmittance to visible light and low resistance.

A metal thin film such as Au may be used as the lower electrode 46a, but a resistance value of the metal thin film easily increases with increase in light transmittance to 90% or more. For this reason, the TCO is preferred. For example, ITO, IZO, AZO, FTO, SnO₂, TiO₂, ZnO₂, or the like is preferably used, and the ITO is the most preferable in view of process simplicity, low resistance, and high transparency. Note that, the lower electrodes 46a of all the pixels 49 may be coupled and integrated into one unit, or may be divided from pixel to pixel.

The photoelectric conversion layer 46c is made of any material as long as the material absorbs the light and produces the electric charge, such as amorphous silicon, for example. The photoelectric conversion layer 46c made of the amorphous silicon can absorb the light radiating from the scintillator 24 in abroad wavelength band. Since an evaporation process is required for forming the photoelectric conversion layer 46c of the amorphous silicon, a heat-resistant glass substrate is preferably used as the sensor substrate 33.

The TFT 47 is constituted of a lamination of a gate electrode, a gate insulating film, and an active layer (channel layer). A source electrode and a drain electrode are formed on the active layer with a predetermined gap therebetween. The active layer is made of any material out of amorphous silicon, amorphous oxide, an organic semiconducting material, a carbon nanotube, and the like, but the material for making the active layer is not limited to them.

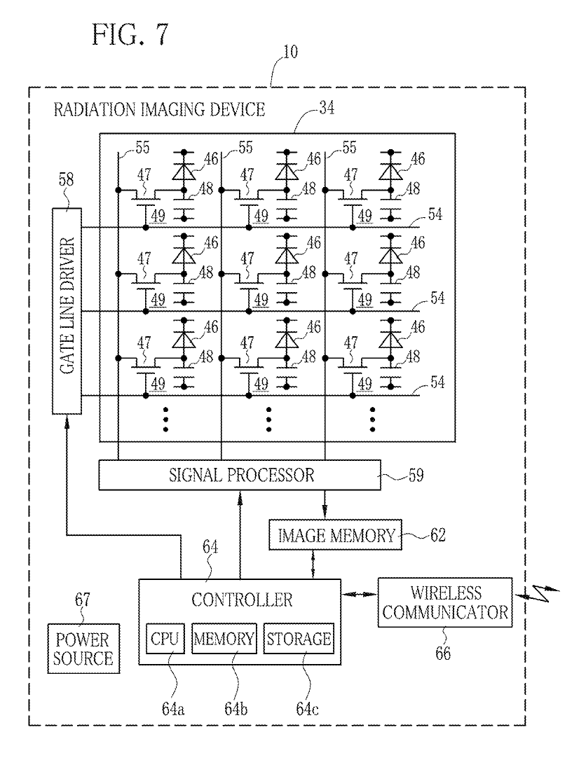

As shown in FIG. 7, the photosensor 34 has plural gate lines 54 extending in a certain direction (row direction), and plural data lines 55 extending in a direction (column direction) intersecting with the above certain direction. The TFTs 47 are turned on or off on a row-by-row basis in response to a signal from the gate lines 54. When the TFT 47 is turned on, the electric charge accumulated in the capacitor 48 (and the middle between the lower electrode 46a and the upper electrode 46b of the photoelectric converter 46) is read out through the data lines 55.

Every gate line 54 of the sensor panel 23 is connected to a gate line driver 58, and every data line 55 is connected to a signal processor 59. When the radiation (radiation having image information of the body part of the patient) transmitted through the body part of the patient is incident upon the radiation imaging device 10, the scintillator 24 emits the light from a position corresponding to a radiation irradiation position of the radiation receiving surface 11 by an amount corresponding to a radiation irradiation amount of each radiation irradiation position. The photoelectric converter 46 of each individual pixel unit 49 produces the electric charge by an amount corresponding to the amount of the light radiating from the corresponding position of the scintillator 24. The electric charge is accumulated in the capacitor 48 (and the middle between the lower electrode 46a and the upper electrode 46b of the photoelectric converter 46) of each pixel unit 49.

After the electric charge is accumulated in the capacitor 48 of every pixel unit 49, as described above, the TFTs 47 of the pixel units 49 are successively turned on by the signal sent from the gate line driver 58 through the gate lines 54 on a row-by-row basis. The electric charge accumulated in the capacitors 48 of the pixel units 49 being turned on is transferred through the data lines 55 to the signal processor 59, as analog pixel signals. Thus, the electric charge accumulated in the capacitor 48 of every pixel unit 49 is successively read out on a row-by-row basis.

The signal processor 59 includes one amplifier and one sample holding circuit for each data line 55. The pixel signal transferred through each data line 55 is amplified by the amplifier, and then held by the sample holding circuit. Outputs of all the sample holding circuits are connected to a multiplexer and an A/D (analog/digital) converter. The pixel signals held by each sample holding circuit are successively inputted to the multiplexer in series, and are converted by the A/D converter into digital image data (image signal).

The signal processor 59 is connected to an image memory 62. The image data outputted from the A/D converter of the signal processor 59 is successively written to the image memory 62. The image memory 62 has a storage capacity of plural frames of the image data. Whenever the radiographic image is captured, the captured image data is stored to the image memory 62.

The image memory 62 is connected to a controller 64 for controlling the operation of the entire radiation imaging device 10. The controller 64 is composed of a microcomputer, which includes a CPU 64a, a memory 64b having a ROM and a RAM, and nonvolatile storage 64c such as a HDD (hard disk drive) and a flash memory.

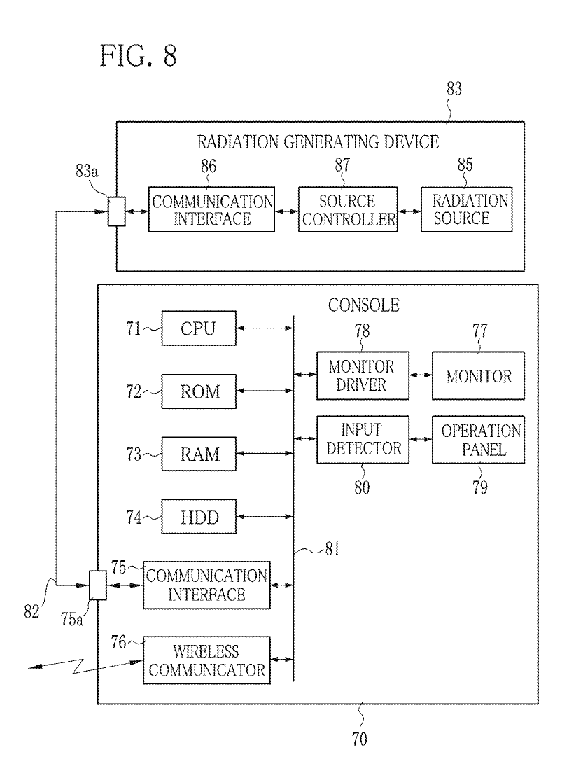

The controller 64 is connected to a wireless communicator 66. The wireless communicator 66 is compatible with a wireless LAN (local area network) standard typified by IEEE (Institute of Electrical and Electronics Engineers) 802.11a/b/g/n. The wireless communicator 66 controls transmission of various types of information to/from external equipment through a wireless network. The controller 64 performs wireless communication with a console 70 (see FIG. 8) through the wireless communicator 66, to send and receive various types of information to and from the console 70.

The radiation imaging device 10 is provided with a power source 67 that supplies electric power to various electric circuits described above (the gate line driver 58, the signal processor 59, the image memory 62, the wireless communicator 66, the controller 64, and the like). The power source 67 contains the rechargeable battery (secondary battery), so as not to impair portability of the radiation imaging device 10. The gate line driver 58, the signal processor 59, the image memory 62, the controller 64, and the power source 67 are contained in the case 20 or provided on the control board 29.

As shown in FIG. 8, the console 70, composed of a computer, is provided with a CPU 71 for controlling the operation of an entire system, a ROM 72 for storing in advance various types of programs including a control program, a RAM 73 for temporarily storing various types of data, and a HDD 74 for storing various types of data. The CPU 71, the ROM 72, the RAM 73, and the HDD 74 are connected to each other through a bus 81. To the bus 81, a communication interface 75 and a wireless communicator 76 are connected. A monitor 77 is also connected to the bus 81 via a monitor driver 78. An operation panel 79 is connected to the bus 81 via an input detector 80.

The communication interface 75 is connected to a radiation generating device 83 through a connection terminal 75a, a communication cable 82, and a connection terminal 83a of the radiation generating device 83. The CPU 71 sends and receives various types of information such as exposure conditions to and from the radiation generating device 83 through the communication interface 75. The wireless communicator 76 has the function of performing the wireless communication with the wireless communicator 66 of the radiation imaging device 10. The CPU 71 sends and receives various types of information such as the image data to and from the radiation imaging device 10 through the wireless communicator 76. The monitor driver 78 produces and outputs a signal for displaying various types of information on the monitor 77, and the CPU 71 displays an operation menu, the captured radiographic image, and the like on the monitor 77 through the monitor driver 78. The operation panel 79 has plural keys or buttons. Various types of information and operation commands are inputted from the operation panel 79. The input detector 80 detects operation on the operation panel 79, and informs the CPU 71 of a detection result.

The radiation generating device 83 is provided with a radiation source 85, a communication interface 86, and a source controller 87. The communication interface 86 sends and receives various types of information such as the exposure conditions to and from the console 70. The source controller 87 controls the radiation source 85 based on the exposure conditions (including information of tube voltage and tube current) received from the console 70.

Next, the operation of this embodiment will be described. In performing radiography with the use of the radiation imaging device 10, a doctor or a radiologic technologist disposes the radiation imaging device 10 between the patient's body part to be imaged and an imaging table, such that the radiation receiving surface 11 faces upward, and adjusts the direction, the position, and the like of the radiation imaging device 10 as a preparation.

When the preparation is completed, a start of radiography is commanded from the operation panel 79. Thus, the console 70 sends the command signal for commanding a start of exposure to the radiation generating device 83, so the radiation generating device 83 emits the radiation from the radiation source 85. The radiation from the radiation source 85 transmits through the body part to be imaged, and is incident upon the radiation receiving surface 11 of the radiation imaging device 10. Then, the radiation enters the scintillator 24 through the top plate 13 and the sensor panel 23.

The radiation that has entered the scintillator 24 is mostly converted into the light in the vicinity of the radiation incident surface of the scintillator 24 in the first conversion layer 40. The remaining radiation that has passed through the first conversion layer 40 is converted into the light in the second conversion layer 41. The GOS has higher light emission efficiency than that of the columnar crystals of CsI, because of a higher filling rate. In addition, the radiation is converted into the light in the two layers of the first and second conversion layers 40 and 41, so conversion efficiency becomes further higher in this embodiment. Therefore, the sensitivity of the radiation detector 19 is improved.

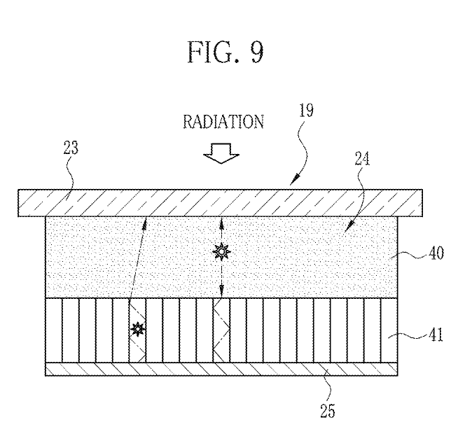

As shown in FIG. 9, in the radiation detector 19 of this embodiment, the light converted in the first conversion layer 40 radiates in all directions. Out of this light, the light heading for a side of the sensor panel 23 enters the sensor panel 23 at a position near a light emitting position, because the distance between the sensor panel 23 and the first conversion layer 40 is short. Thus, the light converted in the first conversion layer 40 does not cause a blur in the radiographic image. Out of the light converted in the first conversion layer 40, the light heading for a side of the reflective layer 25 propagates through the first and second conversion layers 40 and 41, and is reflected from the reflective layer 25. The reflected light propagates again through the second and first conversion layers 41 and 40, and enters the sensor panel 23. Thus, the light heading for the side of the reflective layer 25 travels much longer distance than that of the light directly heading for the sensor panel 23.

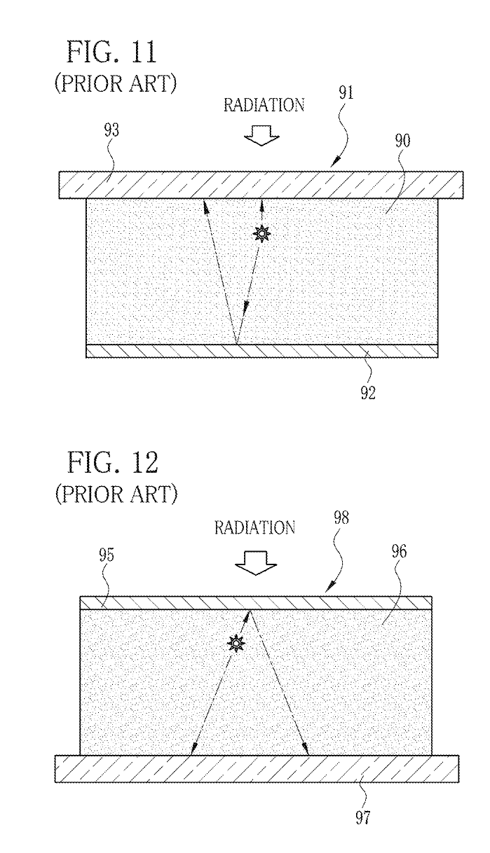

As shown in FIG. 11, in a conventional radiation detector 91 using a planar scintillator 90, light produced in the vicinity of a radiation incident surface of the scintillator 90 sometimes propagates through the scintillator 90 to a reflective layer 92 with getting away from a light emitting position in an in-plane direction of the scintillator 90. At this time, the light reflected from the reflective layer 92 gets further away from the light emitting position while propagating to a sensor panel 93. Thus, such light enters not a pixel unit near the light emitting position but a pixel unit away from the light emitting position, and causes a blur in the radiographic image.

On the contrary, in the scintillator 24 of this embodiment, as shown in FIG. 9, the light travelling from the first conversion layer 40 to the second conversion layer 41 propagates through the optical fiber 43 with the total reflection by a light guide effect of each optical fiber 43, and reaches the reflective layer 25. The light is reflected from the reflective layer 25, and propagates with a guide of the optical fiber 43 to the sensor panel 23. Thus, the light enters the pixel unit 49 near the light emitting position of the first conversion layer 40. For this reason, it is possible to prevent the blur of the radiographic image, and improve the resolution and sharpness of the radiographic image to a similar extent to the scintillator of CsI, with the use of the scintillator 24 of GOS. Also, the light converted from the radiation in the second conversion layer 41 propagates with the guide of the optical fiber 43 to the direction of the sensor panel 23 or the reflective layer 25. Therefore, the light converted in the second conversion layer 41 also contributes to the improvement of the resolution and sharpness of the radiographic image.

The sensor panel 23 detects the light that has entered the pixel units 49 as the radiographic image, and stores image data on the image memory 62. The CPU 64a sends the image data stored on the image memory 62 to the console 70 through the wireless communicator 66. The CPU 71 of the console 70 stores the image data received from the radiation imaging device 10 on the HDD 74 via the RAM 73. The CPU 71 also displays the radiographic image, composed of the image data stored on the HDD 74, on the monitor 77 through the monitor driver 78.

As described above, the radiation detector 19 of the ISS method requires the light guide effect in propagating the light heading for the reflective layer 25 on the opposite side of the sensor panel 23, out of the light produced in the first conversion layer 40. Thus, the use of the planar first conversion layer 40 and the columnar second conversion layer 41 laminated to each other is highly effective for the ISS method. On the other hand, in a radiation detector 98 of the PSS method in which a reflective layer 95, a scintillator 96, and a sensor panel 97 are disposed in this order from the radiation irradiation side, as shown in FIG. 12, both light produced on the side of a radiation incident surface of the scintillator 96 and heading for the sensor panel 97 and light reflected from the reflective layer 95 and heading for the sensor panel 97 require the light guide effect. In this case, making the entire scintillator 96 into the form of columns is more effective than laminating the planar first conversion layer 40 and the columnar second conversion layer 41, as described in this embodiment. In other words, the structure of this embodiment is effective for the ISS method, rather than for the PSS method. The present invention is applicable to the PSS method, but is of great value in the radiation detector of the ISS method.

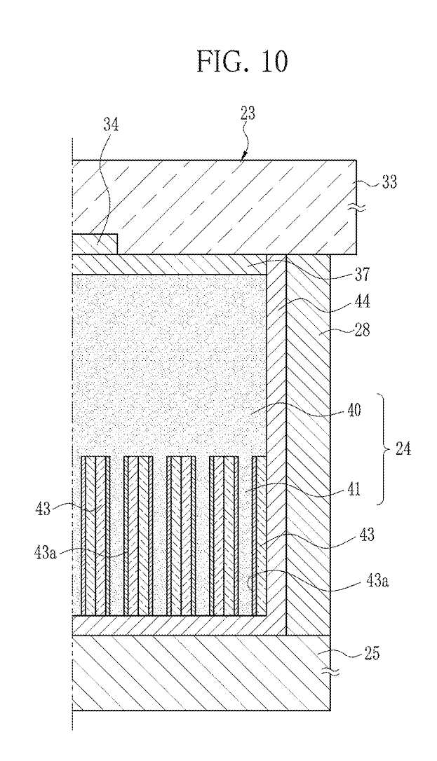

In the above embodiment, the FOP 42 is used as the second conversion layer 41. As shown in FIG. 10, a reflective film 43a such as an aluminum film may be formed in advance in an interior surface of each optical fiber 43. The reflective film 43a increases reflection efficiency, and improves the light guide effect of the optical fiber 43. Therefore, it is possible to further improve the resolution and sharpness of the radiographic image.

The plastic scintillator of the GOS is used in the above embodiment, but another type of plastic scintillator of, for example, a PET resin having PET (polyethylene terephthalate) as the main ingredient may be used instead. As National Institute of Radiological Sciences describes in detail (http://www.nirs.go.jp/information/press/2010/05_{—}19_{—}1.shtml), application of radiation to the PET resin produces light detectable by a photomultiplier tube. Thus, the scintillator of the PET resin is applicable to an indirect conversion type radiation detector used in this embodiment. Use of the PET resin contributes large cost reduction of the scintillator, and allows provision of an inexpensive radiation imaging device.

In the above embodiment, the photoelectric conversion layer 46c of the photoelectric converter 46 is made of amorphous silicon, but may be made of a material including an organic photoelectric conversion material. In this case, an absorption spectrum represents its peak mainly in a visible light range, and the photoelectric conversion layer 46c hardly absorbs an electromagnetic wave except for the light radiating from the scintillator 24. Thus, it is possible to prevent the occurrence of noise caused by absorption of the radiation such as the X-rays or γ-rays by the photoelectric conversion layer 46c. The photoelectric conversion layer 46c made of the organic photoelectric conversion material can be formed by adhesion of the organic photoelectric conversion material on the sensor substrate 33 using a liquid discharge head such as an inkjet head, so heat resistance is not required of the sensor substrate 33. Thus, the sensor substrate 33 may be made of a material other than glass.

When the photoelectric conversion layer 46c is made of the organic photoelectric conversion material, the photoelectric conversion layer 46c hardly absorbs the radiation. Thus, in the radiation detector 19 of the ISS method, it is possible to minimize attenuation of the radiation transmitting through the sensor panel 23 and hence reduction of radiation sensitivity. For this reason, making the photoelectric conversion layer 46c of the organic photoelectric conversion material is suitable in particular for the ISS method.

It is preferable that an absorption peak wavelength of the organic photoelectric conversion material for making the photoelectric conversion layer 46c is as near as possible to an emission peak of the scintillator 24, for the purpose of the most efficiently absorbing the light radiating from the scintillator 24. The absorption peak wavelength of the organic photoelectric conversion material ideally coincides with the emission peak wavelength of the scintillator 24, but if not, the less the difference therebetween, the more light is absorbed. To be more specific, the difference between the absorption peak wavelength of the organic photoelectric conversion material of the photoelectric conversion layer 46c and the emission peak wavelength of the scintillator 24 by application of the radiation is preferably 10 nm or less, and more preferably 5 nm or less.

As the organic photoelectric conversion material satisfying such a condition, there are quinacridone organic compounds and phthalocyanine organic compounds, for example. Since the absorption peak wavelength of quinacridone in the visible light range is 560 nm, the organic photoelectric conversion material having the emission peak wavelength of 560±5 nm is preferably used.

The photoelectric conversion layer 46c applicable to the sensor panel 23 will be concretely described. In the sensor panel 23, an electromagnetic wave absorption and photoelectric conversion portion is constituted of an organic layer including the electrodes 46a and 46b and the photoelectric conversion layer 46c sandwiched between the electrodes 46a and 46b (see FIG. 6). This organic layer specifically includes an electromagnetic wave absorbing portion, a photoelectric conversion portion, an electron transport portion, a hole transport portion, an electron blocking portion, a hole blocking portion, a crystallization preventing portion, electrodes, an interlayer contact improving portion, and the like that are stacked or mixed.

The above organic layer preferably contains an organic p-type compound or an organic n-type compound. The organic p-type compound is a donor organic semiconductor (compound) mainly typified by a hole transport organic compound, and has the property of donating electrons. In more detail, when two types of organic materials are used in contact with each other, the organic p-type compound is an organic compound having less ionization potential. Accordingly, any organic compound is available as the donor organic compound as long as the organic compound can donate the electrons. The organic n-type compound is an acceptor organic semiconductor (compound) mainly typified by an electron transport organic compound, and has the property of accepting the electrons. To be more specific, when two types of organic materials are used in contact with each other, the organic n-type compound is an organic compound having more electron affinity. Therefore, any organic compound is usable as the acceptor organic compound as long as the organic compound has electron receptivity.

Materials usable as the organic p-type compound and the organic n-type compound and the structure of the photoelectric conversion layer 46c are described in U.S. Pat. No. 7,847,258 corresponding to Japanese Patent Laid-Open Publication No. 2009-32854 in detail, so description thereof will be omitted.

The photoelectric converter 46 may have any structure as long as it includes at least a pair of electrodes 46a and 46b and the photoelectric conversion layer 46c, but preferably has one of an electron blocking layer and a hole blocking layer, and more preferably has both.

The electron blocking layer can be provided between the upper electrode 46b and the photoelectric conversion layer 46c. When bias voltage is applied between the upper electrode 46b and the lower electrode 46a, the electron blocking layer prevents increase of dark current by infusion of the electrons from the upper electrode 46b into the photoelectric conversion layer 46c. An electron donating organic material is used as the electron blocking layer. The concrete material of the electron blocking layer is chosen in accordance with the materials of the adjoining electrode and the adjoining photoelectric conversion layer 46c, and preferably has an electron affinity (Ea) by 1.3 eV or more larger than the work function (Wf) of the material of the adjoining electrode, and preferably has an ionization potential (Ip) equal to or less than the Ip of the material of the adjoining photoelectric conversion layer 46c. The materials usable as the electron donating organic material are described in the U.S. Pat. No. 7,847,258 in detail, and the description thereof will be omitted.

The thickness of the electron blocking layer is preferably 10 nm or more and 200 nm or less, more preferably 30 nm or more and 150 nm or less, the most preferably 50 nm or more and 100 nm or less, in order to certainly bring out a dark current restriction effect and prevent reduction of a photoelectric conversion effect of the photoelectric converter 46.

The hole blocking layer can be provided between the photoelectric conversion layer 46c and the lower electrode 46a. When the bias voltage is applied between the upper electrode 46b and the lower electrode 46a, the hole blocking layer prevents increase of the dark current by infusion of holes from the lower electrode 46a into the photoelectric conversion layer 46c. An electron accepting organic material is used as the hole blocking layer. The concrete material of the hole blocking layer is chosen in accordance with the materials of the adjoining electrode and the adjoining photoelectric conversion layer 46c, and preferably has an ionization potential (Ip) by 1.3 eV or more larger than the work function (Wf) of the material of the adjoining electrode, and preferably has an electron affinity (Ea) equal to or larger than the Ea of the material of the adjoining photoelectric conversion layer 46c. The materials usable as the electron accepting organic material are described in the U.S. Pat. No. 7,847,258 in detail, and the description thereof will be omitted.

The thickness of the hole blocking layer is preferably 10 nm or more and 200 nm or less, more preferably 30 nm or more and 150 nm or less, the most preferably 50 nm or more and 100 nm or less, in order to certainly bring out the dark current restriction effect and prevent reduction of the photoelectric conversion effect of the photoelectric converter 46.

Note that, the positions of the electronic blocking layer and the hole blocking layer are reversed, when the bias voltage is applied such that the holes of the electric charge produced in the photoelectric conversion layer 46c move to the lower electrode 46a, and the electrons move to the upper electrode 46b. Both the electron blocking layer and the hole blocking layer are not necessarily provided. Providing one of the electron blocking layer and the hole blocking layer allows obtainment of a certain degree of the dark current restriction effect.

As the amorphous oxide for forming the active layer of the TFT 47, oxides (for example, In—O oxide) containing at least one of In, Ga, and Zn are preferable, and oxides (for example, In—Zn—O oxide, In—Ga—O oxide, and Ga—Zn—O oxide) containing at least two of In, Ga, and Zn are more preferable, and oxides containing all of In, Ga, and Zn are the most preferable. As In—Ga—Zn—O amorphous oxide, an amorphous oxide of a composition represented by InGaO3(ZnO)m (m represents natural number less than 6) in a crystalline state is preferable, and especially, InGaZnO₄ is more preferable. Note that, the amorphous oxide for forming the active layer is not limited to above.

An organic semiconducting material for forming the active layer includes a phthalocyanine compound, pentacene, vanadyl phthalocyanine, or the like, but is not limited to them. The composition of the phthalocyanine compound is described in U.S. Pat. No. 7,768,002 corresponding to Japanese Patent Laid-Open Publication No. 2009-212389 in detail, so the description thereof will be omitted.

Forming the active layer of the TFT 47 out of one of the amorphous oxides, the organic semiconducting material, a carbon nanotube, and the like can effectively restrict the occurrence of noise, because these materials do not or hardly absorb radiation such as the X-rays.

Forming the active layer of the carbon nanotube can accelerate the switching speed of the TFT 47, and reduce the degree of absorption of light in the visible light range by the TFT 47. When the active layer is formed of the carbon nanotube, the performance of the TFT 47 significantly degrades only by mixture of a slight amount of metal impurity into the active layer. Thus, it is necessary to isolate and extract the carbon nanotube of extremely high purity by centrifugation or the like, for use in the formation of the active layer.

Any of the film of the organic photoelectric conversion material and the film of organic semiconducting material has sufficient flexibility. Thus, a combination of the photoelectric conversion layer 46c made of the organic photoelectric conversion material and the TFT 47 having the active layer made of the organic semiconducting material does not necessarily require high rigidity of the sensor panel 23 to which the weight of the patient is applied as a load.

The sensor substrate 33 can be made of any material as long as it is light transparent and has low radiation absorptivity. Both the amorphous oxide for making the active layer of the TFT 47 and the organic photoelectric conversion material for making the photoelectric conversion layer 46c of the photoelectric converter 46 can be deposited at low temperature. Thus, the sensor substrate 33 can be made of not only a heat-resistant material such as semiconductor, quartz, and glass, but also flexible plastic, aramid, and bio-nanofiber. To be more specific, a flexible substrate made of polyester including polyethylene terephthalate, polybutylene phthalate, or polyethylene naphthalate, polystyrene, polycarbonate, polyether sulfone, polyalirate, polyimid, polycycloolefin, norbornene resin, poly(chlorotrifluoroethylene), or the like is available. Using the flexible substrate made of the plastic contributes to weight reduction and ease of portability. Note that, the sensor substrate 33 may be provided with an insulating layer for securing insulation, a gas barrier layer for preventing transmission of moisture and oxygen, an undercoat layer for improving flatness and adhesion to the electrode, and the like.

Since the aramid can be subjected to a high temperature process of 200° C. or more, a transparent electrode material can be cured at high temperature with reduction of resistance therein, and automatic mounting of a driver IC including a reflow soldering process can be performed thereon. The aramid has a thermal expansion coefficient close to those of ITO (indium tin oxide) and the glass substrate, and hence is hard to warp and crack after manufacture. The aramid substrate can be thinner than the glass substrate. Note that, to form the sensor substrate 33, an ultra-slim glass substrate may be laminated with the aramid.

The bio-nanofiber is a complex of a cellulose microfibril bundle (bacterial cellulose) produced by bacteria (acetobacter xylinum) and transparent resin. The cellulose microfibril bundle has a width of 50 nm, being one-tenth of the wavelength of the visible light, and high strength, high elasticity, and low thermal expansion. Impregnating the transparent resin such as acrylic resin or epoxy resin to the bacterial cellulose and hardening it make it possible to obtain the bio-nanofiber that contains fiber at 60 to 70% and has light transmittance of approximately 90% at a wavelength of 500 nm. The bio-nanofiber has a low thermal expansion coefficient (3 to 7 ppm) comparable to a silicon crystal, high strength (460 MPa) comparable to steel, high elasticity (30 GPa), and flexibility. Therefore, the sensor substrate 33 of the bio-nanofiber can be thinner than that of the glass.

When the glass substrate is used as the sensor substrate 33, the thickness of the entire sensor panel 23 is of the order of 0.7 mm, for example. On the other hand, through the use of a thin substrate made of the light transparent plastic as the sensor substrate 33, the thickness of the entire sensor panel 23 can be thinned to the order of 0.1 mm, for example, and the sensor panel 23 is made flexible. The flexibility of the sensor panel 23 improves impact resistance of the radiation imaging device 10, so the radiation imaging device 10 becomes hard to break. Any of the plastic resin, the aramid, the bio-nanofiber, and the like hardly absorbs the radiation. Thus, when the sensor substrate 33 is formed of these materials, the sensor substrate 33 hardly absorbs the radiation. Therefore, even in the ISS method in which the radiation transmits through the sensor panel 23, sensitivity to the radiation is not degraded.

In the above embodiment, the sensor panel 23 has the photosensor 34 composed of the photoelectric converters 46 and the TFTs 47, but may have a CMOS sensor or an organic CMOS sensor that uses the organic photoelectric conversion material in the photoelectric converters (photodiodes), instead. The CMOS sensor or the organic CMOS sensor, which uses single crystalline silicon in its substrate, has faster carrier mobility by three to four digits than that of the photoelectric converter of the amorphous silicon, and has high radiation transmittance. Thus, the CMOS sensor or the organic CMOS sensor is suitably used in the radiation detector of the ISS method. Note that, the organic CMOS sensor is described in detail in United States Patent Application Publication No. 2009/224162 corresponding to Japanese Patent Laid-Open Publication No. 2009-212377, so detailed description thereof will be omitted.

To impart flexibility to the CMOS sensor or the organic CMOS sensor, the CMOS sensor or the organic CMOS sensor may be made of organic thin film transistors formed on a plastic film. The organic thin film transistor is described in detail in Tsuyoshi SEKITANI et al. “Flexible organic transistors and circuits with extreme bending stability” published in Nature Materials 9 on Nov. 7, 2010 on pages 1015-1022, so detailed description thereof will be omitted.

To impart flexibility to the CMOS sensor or the organic CMOS sensor, the photodiodes and the transistors made of single crystalline silicon may be laid out on a flexible plastic substrate. To lay out the photodiodes and the transistors on the plastic substrate, for example, a fluidic self-assembly (FSA) method is available in which device blocks of the order of several tens of micrometers are dispersed in a solution to lay out the device blocks in necessary arbitrary positions on the substrate. Note that, the FSA method is described in detail in Koichi MAEZAWA et al. “Fabrication of Resonant Tunneling Device Blocks for Fluidic Self-Assembly” IEICE Technical Report, Vol. 108, No. 87, pages 67-72, June 2008, so detailed description thereof will be omitted.

In the above embodiment, the radiation detector is contained in the housing of the cassette size, but may be mounted in an upright or horizontal imaging device or in a mammography device. The present invention is applicable to a device using any type of radiation including γ-rays and the like, instead of the X-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A radiation detector comprising:
a first conversion layer for converting radiation into light, said first conversion layer being formed of a planar phosphor;
a second conversion layer for converting said radiation into said light, said second conversion layer being formed of a columnar phosphor, said second conversion layer being integrated with said first conversion layer to form a scintillator; and
a sensor panel overlaid on said scintillator, said sensor panel having a detection surface having a two-dimensional array of pixels each for converting said light produced by said scintillator into an electric signal; wherein
said scintillator is disposed in a position such that said first conversion layer faces to a radiation irradiation side; and
said sensor panel is disposed in a position such that said detection surface faces to an outer surface of said first conversion layer.

2. The radiation detector according to claim 1, wherein said second conversion layer has a fiber optic plate made of a bundle of hollow optical fibers and a phosphor filling each of said optical fibers.

3. The radiation detector according to claim 2, further comprising a reflective layer for reflecting said light converted by said scintillator to said sensor panel, said reflective layer being formed on an outer surface of said second conversion layer.

4. The radiation detector according to claim 3, wherein said reflective layer is a mirror-finished metal plate.

5. The radiation detector according to claim 3, wherein a reflective film is formed in an interior surface of each of said optical fibers.

6. The radiation detector according to claim 5, wherein said reflective film is an aluminum film.

7. The radiation detector according to claim 3, wherein said phosphor used in said first and second conversion layers is a plastic scintillator.

8. The radiation detector according to claim 7, wherein said plastic scintillator contains GOS particles dispersed in a resin binder.

9. The radiation detector according to claim 3, wherein said first conversion layer is thicker than said second conversion layer.

10. The radiation detector according to claim 3, wherein said scintillator is covered with a moisture-proof protective film.

11. A scintillator comprising:
a first conversion layer for converting radiation into light, said first conversion layer being formed of a planar phosphor; and
a second conversion layer for converting said radiation into said light, said second conversion layer having a fiber optic plate made of a bundle of hollow optical fibers and a phosphor filling each of said optical fibers.

12. The scintillator according to claim 11, wherein a reflective film is formed in an interior surface of each of said optical fibers.

13. The scintillator according to claim 12, wherein said phosphor is GOS.

14. A manufacturing method of a scintillator comprising the steps of:
filling each of a plurality of optical fibers of a fiber optic plate with a phosphor paste to form a second conversion layer having a plurality of columnar phosphors; and
applying said phosphor paste to one surface of said fiber optic plate to form a first conversion layer integrally with said columnar phosphors.

15. The manufacturing method according to claim 14, said phosphor paste contains GOS.

16. The manufacturing method according to claim 15, wherein the filling step uses a capillary phenomenon by immersion of said optical fibers in said phosphor paste.
